(19) United States
(12) Patent Application Publication
(10) Pub. No.: US 2012/0210296 A1
(43) Pub. Date: Aug. 16, 2012

(54) AUTOMATICALLY CREATING BUSINESS APPLICATIONS FROM DESCRIPTION OF BUSINESS PROCESSES

(75) Inventors: Mark Boulter, Monroe, WA (US); Greg Lindhorst, Seattle, WA (US); Erik Kennedy, Seattle, WA (US); Todd Haugen, Seattle, WA (US); Steve Greenberg, Seattle, WA (US); Ryan McMinn, Seattle, WA (US); Wesley Hodgson, Seattle, WA (US); Krunal Sheth, Sammamish, WA (US)

(73) Assignee: MICROSOFT CORPORATION, Redmond, WA (US)

(21) Appl. No.: 13/107,227

(22) Filed: May 13, 2011

Related U.S. Application Data
(60) Provisional application No. 61/442,517, filed on Feb. 14, 2011.

(51) Int. Cl. G06F 9/44

(52) U.S. Cl. 717/107

(57) ABSTRACT

An application builder tool creates business applications from user provided business descriptions. The application builder is customized using metadata and the metadata may be extended. The metadata provides a set of business terms to the user and the information required to generate an application from those terms. The user either selects terms from the list or enters new business terms to describe the business problem they want the application to automate. The application builder analyzes the terms the user provides and uses the metadata associated with those terms to select, generate and combine business application components. The result is a functioning business application.

### CROSS REFERENCE TO RELATED APPLICATIONS

This application claims the benefit of U.S. Provisional Patent Application Ser. No. 61/442,517 filed on Feb. 14, 2011. The disclosures of the provisional patent application are hereby incorporated by reference for all purposes.

### BACKGROUND

Hosted or locally installed business applications create, monitor, and otherwise process requests, orders, quotations, and comparable business operations. Many business applications also integrate operational aspects such as manufacturing, inventory, planning, and purchasing operations, sometimes enabling interaction between suppliers and consumers of goods and services.

The business experts who own the business processes that these business applications automate are often best placed to build such business applications. However, they often have little or no programming experience and the available programming tools to build these types of applications typically require database and programming expertise. This puts such tools beyond the reach of many of these business experts.

The application building tools that are available today are inflexible, incomplete, too narrow in scope, or so complex that they are as difficult to understand as the programming tools they are supposed to replace. For example, point solutions (pre-packaged applications) are limited because of either lack of support for customization or limited customization facilities. Templates for programming tools (pre-packaged solutions that can be modified in the tool) are an alternative solution that has had some success but those also suffer from a number of drawbacks. The underlying programming tool may still require a user to have database and programming expertise. Additionally, it is often challenging to find the template best suited to solve a business problem. A suitable template may often be complex and difficult for the user to understand and modify. Furthermore, templates tend to be “islands” of functionality that are hard to combine. Another common approach is a wizard that prompts the user to make a series of choices and generates an application based on those choices. However, typically, wizards are not re-entrant (i.e., they support generating not editing) and do not use an extensible metadata scheme that allows for update and extension. This limits the usefulness of such wizards.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an application builder tool for automatically creating business applications from business process descriptions provided by a user. The application builder tool may be customized using metadata. The metadata provides a set of business terms to the user and the information for generating an application from those terms. The user may either select terms from the list or enter new business terms to describe the business problem they want the application to automate. The application builder may analyze the terms the user provides and use the metadata associated with those terms to select, generate and combine business application components. The application builder may use the metadata to make context sensitive suggestions for additional choices. These additional choices cause additional application components to be generated. The result is a functioning application. The generation process is re-entrant—the user can use the system to both generate new application components and to edit existing ones. The metadata and the application builder may both be extended in a way that allows the system to be tuned based on the choices users make—as more users utilize the system and make choices, the solutions provided by the system for those choices improves.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a networked environment, where an application builder may generate a business application employing extensible metadata extracted from business terms provided by a client application according to some embodiments;

FIG. 2 illustrates a screenshot of an example interface with selectable business terms to build a business application;

FIG. 3 illustrates another screenshot of an example interface providing searchable business terms to build a business application;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process automatically creating business applications from business description of problems according to embodiments.

### DETAILED DESCRIPTION

As briefly described above an application builder may automatically create business applications from user provided business descriptions. The application builder is customized using metadata and the metadata may be extended. The metadata provides a set of business terms to the user and the information for generating an application from those terms. The user may either select terms from the list or enter new business terms to describe the business problem they want the application to automate. The application builder may analyze the terms the user provides and use the metadata associated with those terms to select, generate and combine business application components. The application builder may use the metadata to make context sensitive suggestions for additional choices. These additional choices cause additional application components to be generated. The result is a functioning application. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing business applications and/or similar business services. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

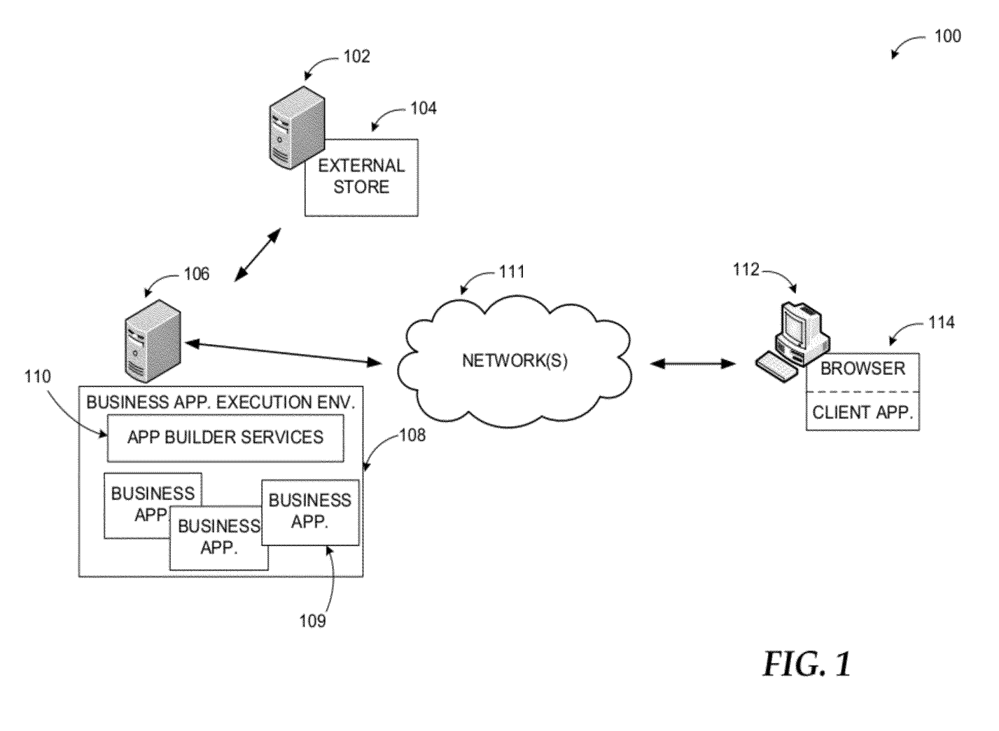

Referring to FIG. 1, diagram 100 illustrates a networked environment, where an application builder may generate a business application from a metadata driven description of the business problem provided by a client application according to some embodiments. The computing devices and computing environments shown in diagram 100 are for illustration purposes. Embodiments may be implemented in various local, networked, and similar computing environments employing a variety of computing devices and systems.

In an example environment illustrated in diagram 100, a client application 114 (e.g. a browser) executed on client device 112 may display a user interface (UI) to access a business application 109 executed on server 106 within an business application execution environment 108 providing (among other things) application building services 110. A user (regardless of expertise) may access the business application 109 through the UI displayed by the client application 114. A user may also access the application builder services 110 provided by the business application execution environment 108 through the UI displayed by the client application 114. The user may provide a business process or problem description through the client application 114. The client application 114 may be running in a web browser, or on a phone, slate, or similar device. Client application 114 and business application execution environment 108, business application 109 and application builder services 110 may communicate over one or more networks such as network(s) 111, which may be secure or insecure, enterprise, public, wired, wireless, cellular, etc. Furthermore, data associated with the business processes, business application components, business application builder services, business application execution environment and created business applications may be stored locally or at an external data store 104 managed by server 102, for example.

The user may access the application builder services 110 to quickly and easily build a business application. The user may build the business application to address business needs. The business application may be shared with co-workers, collaborators, etc. The application builder services 110 may enable a friction-free path to customized business applications by automating the business application development process and enabling business experts to describe the problem in terms of the business entities they want to manipulate or the business process they wish to automate rather than in terms of programming such as database schemas and programming code.

Application templates are an alternative solution that has been used by programming tools and application builder tools to simplify the process of building business applications. However, application templates have a number of drawbacks. Application templates are an optional path in programming tools and application builder tools. As such, the application templates are usually not well integrated into the product and the tool may not be optimized for selecting and customizing an application template. A user may have to search through a catalog of templates to find a template that matches the business process that they wish to automate. To accomplish this task they have to understand the business process, the terms used by the tool and the contents of the template. Search and catalog solutions may also be primitive making it harder to find an appropriate template.

Upon finding an application template that may meet their needs, a user may need to download and install the application template to the programming tool and explore the template in detail in order to determine if it is a good match. If the template does appear to be a good match they the user may need to understand how it is constructed in order to customize it further. This may require programming and database expertise.

Programming tools and application builder tools are usually not tuned to exploration and customization of an existing application template. Even something as simple as adding a new field to a table may prove to be a challenge. Something as complex as adding a new table and integrating it into the application may be beyond the skill of people who are not expert programmers.

Similar search, download, install, exploration and customization processes may have to be repeated for each business application the user wishes to build.

Users wishing to combine elements of different application templates together may face multiple challenges. In an example scenario, a user may wish to create a business application to keep track of employee names and addresses. They may be able to do this by finding and selecting an application template that generates a contact management application. At a later date, the user may wish to add the ability to track employees and their computers. In application template based programming tools, the user may have no way to merge the template that generates an asset management application with existing contact management application and map the “Contacts” table to an “Employees” table to extend their existing application.

Embodiments of an application builder automatically constructing business applications may address deficiencies of application template based solutions outlined above as follows:
1. The application builder tool will provide units of consumption (“business application components”) that are smaller than a complete application template.
2. The application builder tool will provide rules that govern how business application components may be combined.
3. Selecting and customizing business application components will be the primary path in the application builder tool and the application builder tool will be optimized for that purpose.
4. The application builder tool will provide a targeted search engine designed to help business experts to select business application components.
5. The application builder tool will allow incremental changes and provide immediate feedback to the user (e.g.: selecting a noun such as “customers” may result in adding a “customers” entry point to a navigation bar in the application.)
   These improvements may make it easier to select, combine, configure and extend business application components to create or modify business applications.

In an embodiment, a user may be enabled to describe a business application using business terms and not programming terms. The user may identify the nouns that are used by the business application they are creating. A noun may represent an entity within the business application. Examples may include customers, assets, or employees. The noun may be a primary object within the business application at runtime and design time. The user may build the business application by identifying nouns and the relationships between them.

The business application builder tool may provide a predefined set of nouns such as customer, product, order, contact, asset, etc. The predefined set of nouns may enable the users to quickly build the business application.

In another embodiment, the user may identify the nouns in the business application by completing simple sentences starting with “I want to”. Examples may include “I want to track assets” or “I want to sell tools to mechanics”. The combination of verbs and nouns in these sentences may allow the business application builder tool to identify and infer business application structure. In the second example the use of the word “sell” may allow the business application builder tool to propose products (tools) and customers (mechanics) as nouns in the application with a relationship between them. The underlying tables such as products, customers, orders, and order details and their relationships may be subsequently generated.

Furthermore, the business application builder tool may guide the user through the process of defining relationships. Rather than exposing the user to complex database diagram notations and concepts like one-to-many and many-to-many, the business application builder tool may use simple sentence structures to engage the user in defining relationships. In an example scenario, “employees are associated with computers” may imply that there is a many-to-many relationship between the employees table and the assets table.

In another embodiment, the business application builder tool may make metadata driven, context sensitive suggestions. The metadata associated with each user choice may allow the business application builder tool to provide suggestions based on those choices. In an example scenario, if the user chooses “sell products”, the business application builder tool may select the products application component and the metadata associated with products may include the suggestion for an orders table. However, if the user chooses “sell houses” the business application builder tool may select the houses application component and the metadata associated with houses may include the suggestion for a sales agreement table. Similarly, the metadata associated with the orders application component may include the suggestion for a “sales by customer” and a “sales by employee” report. If the user chooses the “sales by employee” report, the metadata associated with that report may indicate that a relationship between the employee table and the orders table is required. The metadata can indicate both required and optional relationships. Each user choice may lead the business application builder tool to offer related choices. Each choice the user makes causes the business application builder tool to select and configure business application components.

In another embodiment, metadata in the business application builder tool is encapsulated within a schema part. The metadata within a schema part may provide information about user choices and about the business application components that are generated as a result of those user choices. This information may include, but is not limited to, the following:
1. Descriptive information: nouns, verbs, and synonyms associated with a schema part. This information may be used to populate a choice user interface (UI) and to drive the business application builder tool's search engine.
2. A description of a set of tables, fields associated with the tables, properties associated with the tables, properties associated with the fields and the required and optional relationships with other tables. This information may be used to make suggestions to the user and to create and edit the business application.
3. A description of the queries, forms, reports, UI logic, data logic, and other application assets and resources used to generate application components. This information may be used to make suggestions to the user and to create and edit the business application.
4. A list of related schema parts. This information may be used to make suggestions to the user and to create and edit the business application.
5. The rules for how to relate the tables in a schema part to tables in other schema parts in order to combine schema parts in a predictable fashion. This information may be used to create and edit the business application.

In an example scenario, a contacts schema part may include:

| | | Relation- | | | |
|---|---|---|---|---|---|
| Table | Base Class | ships | Queries | Forms | Rules |
| contacts | People | | | standard | none |

In an alternative example scenario, an order schema part may include:

| Table | Base Class | Relationships | Queries | Forms | Rules |
|---|---|---|---|---|---|
| orders | Transaction | order has | activeorders | orderlist | order must |
| | | many | ordersthismonth | orderdetails | be related to |
| | | orderdetails | salesbycustomer | | customer |
| | | | salesbyemployee | | order can be |
| | | | etc. | | related to |
| | | | | | employee |
| | | | | | order can be |
| | | | | | related to |
| | | | | | invoice |
| orderdetails | | | | | orderdetail |
| | | | | | must be |
| | | | | | related to |
| | | | | | product |

The business application builder tool may use extensible metadata and schema parts. The metadata may be captured in a format allowing both business application builder tool designers and third parties to extend and enhance it over time. The user and organizations may create and share customized schema parts for use in the business application builder tool.

The business application builder tool may be designed to facilitate the dynamic discovery of schema parts. The schema parts may be stored on the local hard disk, distributed with a program suite, stored within an organization's intranet, associated with the user's web service or other cloud persona, or located on the Internet through a search engine.

In other embodiments, the business application builder tool may be extended and improved over time based on usage. The business application builder tool may monitor search terms. The business application builder tool may search an external database storing third party supplied business application components and matching user choices upon an inability to locate a corresponding business application component in the business application builder tool database. Additionally, the business application builder tool application may support extensible metadata and/or dynamic discovery of metadata to enable the business application builder tool designer to extend and improve the business application builder tool based on the search terms and user choices.

In yet other embodiments, the business application builder tool may be re-entrant and support both creation and editing of application components. Each application component generated by a schema part may be uniquely identified and mapped back to that schema part. Each schema part may include rules governing how the schema parts may be edited and combined. The rules may enable the business application builder tool to support both creation and editing of the application components.

In another embodiment, the business application builder tool may allow importation of existing data sets. Importing existing data sets may be either through defined schema parts or through dynamic schema parts supporting schema discovery via external data markets. An example scenario of defined schema parts may be metadata on a contact schema part identifying email services as data sources.

Following may represent business applications that may be built by the business application builder tool according to some example embodiments. It should be noted that the list is exemplary and not exhaustive. Additional business applications may be constructed using the principles described herein.
1. Contact management
2. Asset tracking
3. Student tracking
4. Project management
5. Task management
6. Event planning
7. Issue tracking
8. Inventory
9. Sales pipeline
10. Sales order and invoice processing
11. Membership tracking
12. Schedule management
13. Appointment planner
14. Account ledger
15. Time and Billing
16. Time Sheet

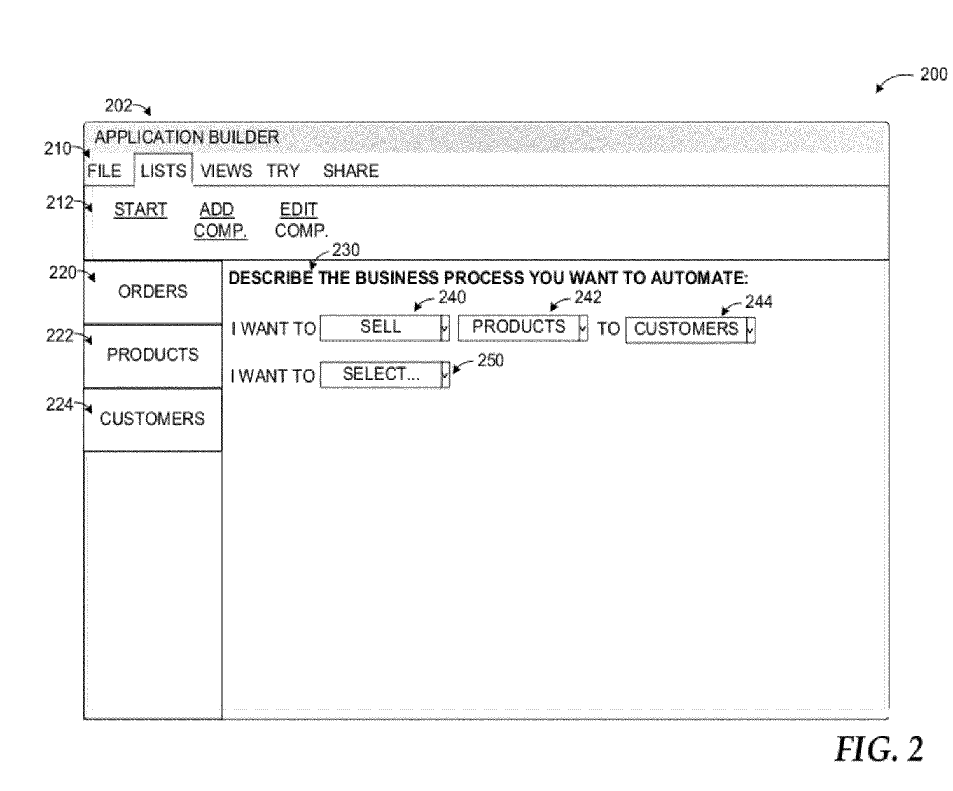

FIG. 2 illustrates a screenshot of an example user interface with selectable business terms to build a business application. Diagram 200 displays a UI presenting a user with tools to build the business application. File menu 210 may provide access to parts of the business application builder tool grouped by different functionality. Pane 212 may display primary functions of the business application builder tool. The primary functions may include routines to add, configure and edit business application components and to test the business application.

Navigation UI 220, 222, and 224 may alter the user choice pane to present the user with choices based on the metadata stored in corresponding tables such as orders, products, and customers, respectively. Based on the user selection of these navigation buttons, the business application builder tool may load a list of choices retrieved from the corresponding metadata stored in the table. User selections may be determined by the business application builder tool based on rules contained in metadata describing the relationships between tables storing the user selections.

The business application builder tool UI 202 may greet the user with a friendly greeting 230. The UI may guide the user based on choices from drop down menu 240 and populate drop down menu 242. User choices from dropdown menus 240 and 242 may guide the available choices in drop down menu 244. The business application builder tool may structure the sentence based on information stored in the metadata describing the relation between user choices and corresponding business application components and how to combine them. The business application builder tool may also provide the user with any additional choice options 250 as needed by the user. The business application builder tool is not bound to only present drop down menus in its choice UI pane. For example, the UI 242 and 244 may provide text boxes for the user to enter any user desired term such as a noun, a verb, etc.

Embodiments are directed to an application builder that may be customized using a metadata driven configuration engine to construct a business application. The metadata may provide, both, a set of user choices (e.g.: nouns and verbs) and the information needed to generate an application from those choices. The user may select the nouns and verbs describing a business problem to automate such as “I want to sell ice cream to children.” The business application builder tool may use an associated metadata to interpret user choices. The business application builder tool may generate the business application components for the selected choices (e.g.: a products table). Additionally, the business application builder tool may make context sensitive suggestions for subsequent user choices (e.g.: “track ice cream sales by employee?”). Additional business application components may be generated upon selection of preceding user choices. Business application generation is, therefore, re-entrant because the business application builder tool may use existing application components and create new application components. The business application builder tool is re-entrant because it can uniquely identify existing application components. In addition, the business application builder tool is re-entrant because metadata may contain rules governing how to combine application components. The metadata and the configuration engine may both be extended to allow the business application builder tool to be tuned based on the user choices registered from user selections and built business applications.

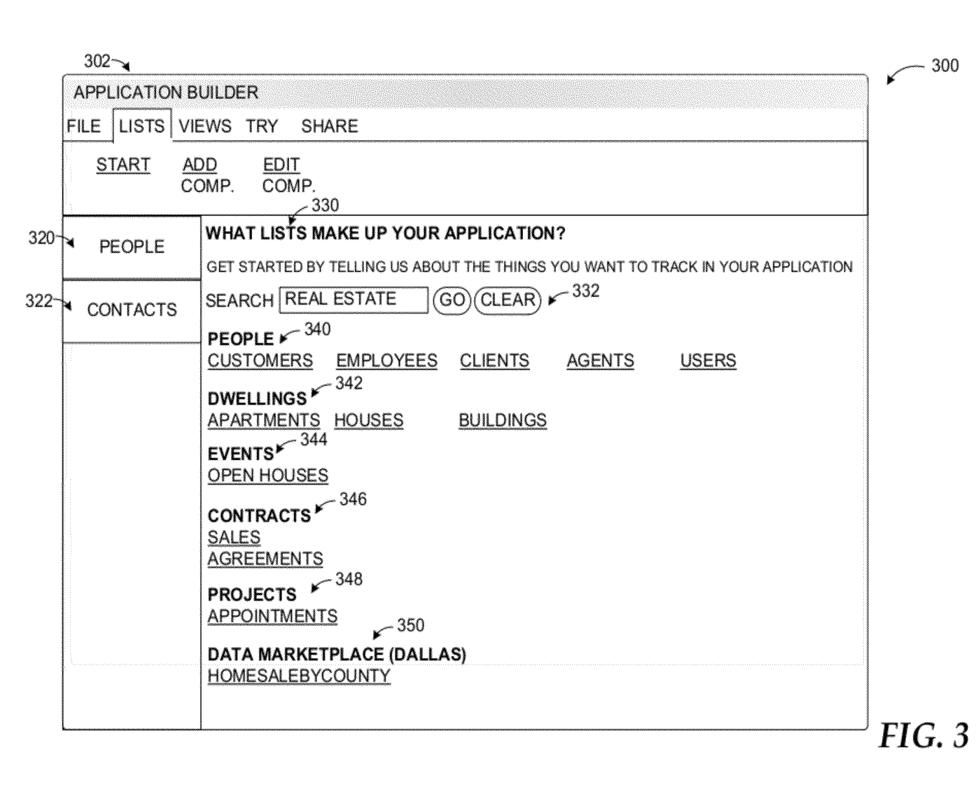

FIG. 3 illustrates another screenshot of an example user interface providing searchable business terms to build an application. Business application builder tool UI 302 may display a greeting 330 and provide search interface to locate list of choices. The user may search the business application builder tool by typing search terms into a search interface 332 for a matching list of choices.

Search results in categories such as people 340, dwellings 342, events 344, contracts 346, projects 348, and data marketplace 350 tables are filled into the choice pane in the example user interface. The user may select one or more lists to populate the choice UI described in diagram 200. Metadata stored in database tables may enable the business application builder tool to combine the list of choices based on the rules relating the choices and corresponding business application components to each other.

The example user interfaces in FIGS. 2 and 3 are shown with specific components, data types, and configurations. Embodiments are not limited to systems according to these example configurations. Automatically creating applications from business description of problems may be implemented in configurations employing fewer or additional components in applications and user interfaces. Furthermore, the example nouns, verbs, sentences, and relationships shown in FIGS. 2 and 3 and their attributes may be implemented in a similar manner with other values using the principles described herein.

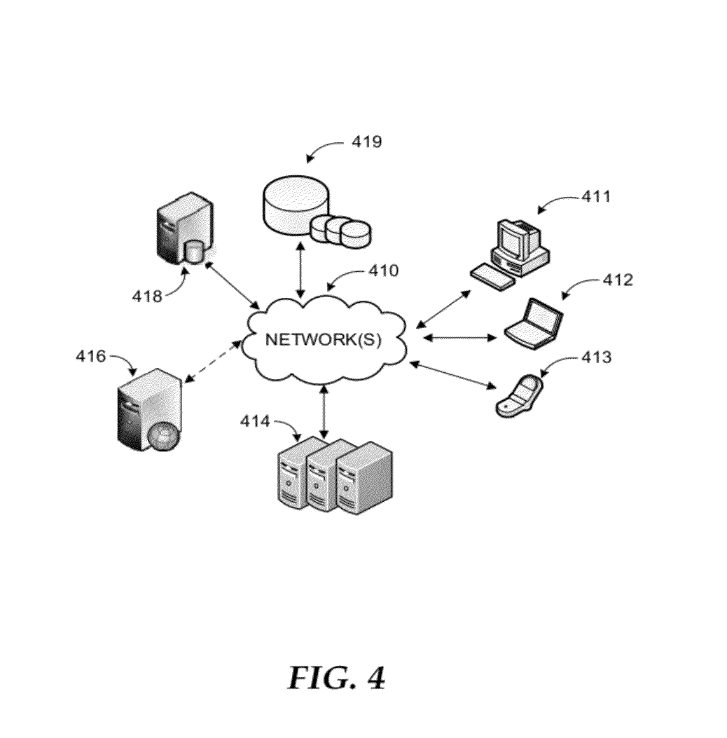

FIG. 4 is a networked environment, where a system according to embodiments may be implemented. Business applications may be automatically created by an application builder executed over one or more servers 414 or a single server (e.g. web server) 416 such as a hosted service. The application builder may communicate with client applications on individual computing devices such as a smart phone 413, a laptop computer 412, or desktop computer 411 ('client devices') through network(s) 410.

As discussed above, business applications may be created by the application builder from extracted business terms of a description of a business process or problem. The application builder may retrieve business application components matching user choices and build the business application according to metadata describing the relationship between the choices and business application components.

Client devices 411-413 may enable access to applications executed on remote server(s) (e.g. one of servers 414) as discussed previously. The server(s) may retrieve or store relevant data from/to data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to automatically build business applications from business descriptions. Furthermore, the networked environments discussed in FIG. 4 are for illustration purposes only. Embodiments are not limited to the example applications, modules, or processes.

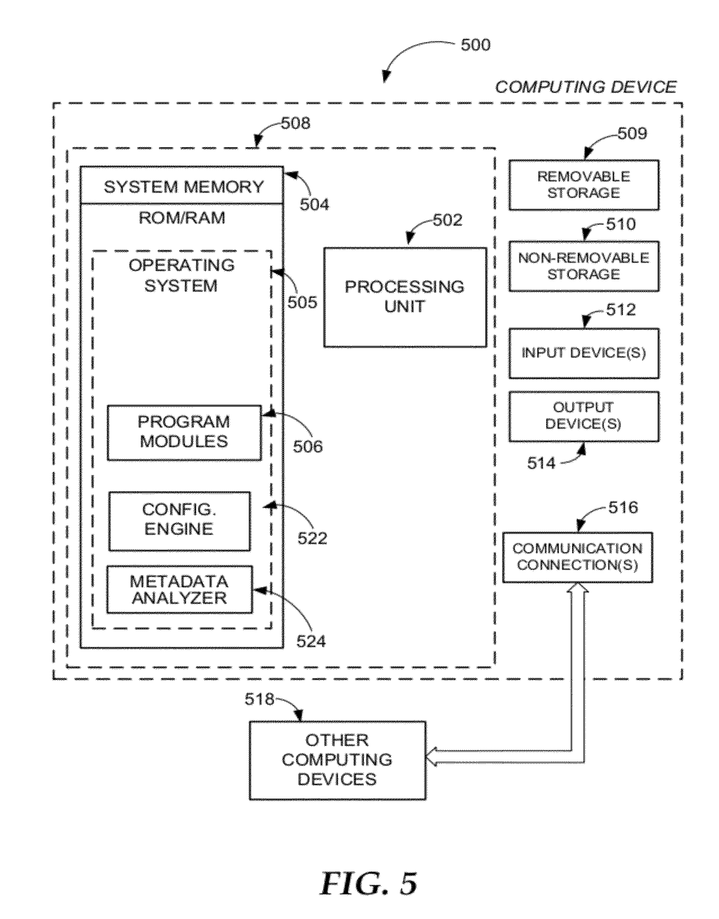

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, configuration engine 522, and metadata analyzer 524.

Configuration engine 522 may be part of an application builder automatically building business applications from business process descriptions and terms extracted from such descriptions such as nouns and verbs. The metadata analyzer may retrieve metadata matching user choices describing corresponding business application components and their relationship to each other and information such as rules on how to combine the business application components. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, storage servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

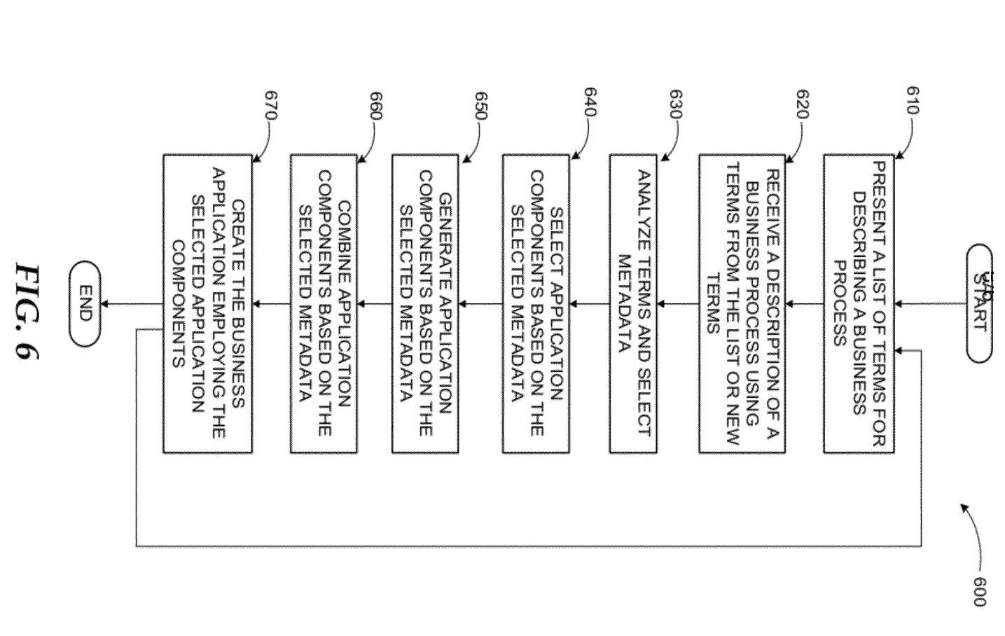

FIG. 6 illustrates a logic flow diagram for a process automatically creating business applications from business description of processes or problems according to embodiments. Process 600 may be implemented by a business application builder service in some examples. The re-entrant nature of the process 600 is illustrated in the figure by the loop between operation 670 and operation 610.

Process 600 may begin with presenting a list of terms for describing a business process at operation 610. FIG. 2 represents an example of a user interface that presents such a list.

The application builder service receives a description for a business application using those terms or terms the user entered at operation 620. Those terms are analyzed and used to select metadata at operation 630. The application builder may select business application components based on the analyzed metadata at operation 640. Additionally the application builder may generate application components (operation 650) and may combine application components (operation 660). Next, the application builder may create the business application employing the selected business application components (e.g.: build a business application to sell goods to a selected market) at operation 670.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 600 are for illustration purposes. Automatically creating business applications from business descriptions of problems may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for automatically creating a business application, the method comprising:
presenting a list of business terms for describing a business process;
receiving a description of a business process using at least one from a set of: terms from the list and user entered terms;
analyzing the received terms and selecting metadata based on the terms;
at least one of: selecting and generating business application components based on the selected metadata;
combining the business application components based on the selected metadata; and
creating the business application employing the combined business application components.

2. The method of claim 1, further comprising:
presenting a list of options associated with the business application components based on the selected metadata;
receiving at least one of a selected option and a user entered option; and
selecting further business application components based on the selected option.

3. The method of claim 2, wherein the options are metadata driven, context sensitive suggestions.

4. The method of claim 1, wherein the list of business terms is metadata driven.

5. The method of claim 1, wherein the list of business terms includes at least one from a set of nouns and verbs.

6. The method of claim 1, wherein the metadata is extensible.

7. The method of claim 1, further comprising:
updating the metadata based on usage;
extending the metadata based on usage.

8. The method of claim 1, further comprising:
editing an existing business application based on the selected metadata.

9. The method of claim 1, wherein the metadata is encapsulated within a schema part, the schema part providing information about user choices and about the business application components generated as a result of the user choices.

10. The method of claim 1, further comprising:
enabling importation of existing data sets through one of defined schema parts and dynamic schema parts supporting schema discovery via external data markets.

11. A computing device for automatically creating a business application, the computing device comprising:
a memory storing instructions; and
a processor coupled to the memory, the processor executing a configuration engine in conjunction with the instructions stored in the memory, wherein the configuration engine is adapted to:
present a list of business terms for describing a business process;
receive a description of a business process using at least one from a set of: terms from the list and user entered terms;
analyze the received terms and select metadata based on the terms;
at least one of: select and generate business application components based on the selected metadata;
combine the business application components based on the selected metadata; and
one of: create the business application employing the selected business application components and edit an existing business application based on the analyzed metadata.

12. The computing device of claim 11, wherein the metadata includes information about a list of options for populating a selection user interface, and wherein a result of a user selection from the list of options is used to generate further business application components.

13. The computing device of claim 12, wherein the information includes nouns, verbs, and synonyms for populating the selection user interface and selecting further business application components to generate.

14. The computing device of claim 12, wherein the information further includes a description of a set of tables, fields associated with the tables, properties associated with the tables, properties associated with the fields, and required and optional relationships with other tables.

15. The computing device of claim 12, wherein the information further includes none or more from a set of: a description of queries, forms, reports, user interface logic, data logic, and application assets and resources associated with the tables.

16. The computing device of claim 12, wherein the information further includes a list of rules relating the tables in one business application component to tables in another business application component in order to combine the business application components in a predictable fashion, the list of rules including one or more of relationships, base classes, class hierarchy, and synonyms.

17. A computer-readable memory device with instructions stored thereon for automatically creating a business application, the instructions comprising:
presenting a list of business terms for describing a business process;
receiving a description of a business process using at least one from a set of: terms from the list and user entered terms;
analyzing the received terms and selecting metadata based on the terms;
at least one of: selecting and generating business application components based on the selected metadata;
combining the business application components based on the selected metadata;
presenting a list of choices associated with the business application components based on the selected metadata;
creating the business application employing the combined business application components; and
employing a set of schema parts in the metadata providing information associated with the list of choices and associated with the business application components that are generated as a result of one or more user selections from the list of choices.

18. The computer-readable memory device of claim 17, wherein the instructions further comprise:
storing the metadata in extensible markup language (XML) format.

19. The computer-readable memory device of claim 17, wherein the instructions further comprise:
storing rules for combining the business application components in the metadata.

20. The computer-readable memory device of claim 17, wherein the rules define how to edit and combine the set of schema parts.
